(19) United States
(12) Patent Application Publication
(10) Pub. No.: US 2024/0227701 A9
(43) Pub. Date: Jul. 11, 2024

(54) GROMMET AND WIRE HARNESS

(71) Applicant: SUMITOMO WIRING SYSTEMS, LTD., Mei (JP)

(72) Inventor: Taiki KOBAYASHI, Mie (JP)

(21) Appl. No.: 18/277,764

(22) PCT Filed: Mar. 2, 2022
(86) PCT No.: PCT/JP2022/008805

§ 371 Date: Aug. 17, 2023

(30) Foreign Application Priority Data
Mar. 4, 2021 (JP) 2021-034581

(51) Int. Cl. B60R 16/02; H02G 3/04

(52) U.S. Cl. CPC B60R 16/0222; H02G 3/0406

(57) ABSTRACT

The objective of the present invention is to provide a technology capable of suppressing torsional deformation in an attachment portion, even if a torsional moment is applied from an electric cable to a grommet. This grommet is provided with a tubular main body portion through which an electric cable is inserted, and an attachment portion used for attachment to an attachment target. The main body portion includes a holding portion used to hold the electric cable, and a linking portion joining the holding portion and the attachment portion. A recessed/protruding portion in which protruding portions and recessed portions are arranged alternately in a circumferential direction about an axis parallel to the insertion direction of the electric cable is provided in the linking portion.

### TECHNICAL FIELD

The present disclosure relates to a grommet and a wire harness.

### BACKGROUND

Patent Document 1 discloses a grommet for vehicles that is configured to protect an electric wire passed through a through hole formed in a panel and prevents water from entering the through hole. The grommet disclosed in Patent Document 1 includes a main body portion that is fitted into the through hole to prevent water from entering the through hole and into which the wire is inserted, and a tubular portion that is formed together with the main body portion into a tubular shape and holds the wire passed through the tubular portion.

### PRIOR ART DOCUMENT

### Patent Document

Patent Document 1: JP 2020-184856 A

### SUMMARY OF THE INVENTION

### Problems to be Solved

Depending on the routing direction of a wire, a torsion moment may be applied to the grommet from the wire. In this case, if no countermeasure is made, the tubular portion that holds the wire as well as an outer circumferential portion (attaching portion to the through hole) of the main body portion may be subjected to torsional deformation.

Therefore, an object is to provide a technique capable of suppressing torsional deformation in an attaching portion even if a torsion moment is applied to a grommet from a wire.

### Means to Solve the Problem

The grommet according to the present disclosure is directed to a grommet including: a main body portion that is tubular and into which a wire is to be inserted; and an attaching portion for use in attaching to a target for attachment, wherein the main body portion includes a holding portion for use in holding the wire, and a linking portion joining the holding portion and the attaching portion, and the linking portion includes a recessed/protruding portion in which protruding portions and recessed portions are alternately arranged in a circumferential direction about an axis that is parallel to an insertion direction of the wire.

### Effect of the Invention

According to the present disclosure, it is possible to suppress torsional deformation in an attaching portion even if a torsion moment is applied to a grommet from a wire.

### BRIEF DESCRIPTION OF THE DRAWINGS

FIG. 1 is a perspective view illustrating a grommet according to Embodiment 1.

FIG. 2 is a plan view illustrating the grommet according to Embodiment 1.

FIG. 3 is a cross-sectional view taken along a line in FIG. 2.

FIG. 4 is a cross-sectional view taken along a line IV-IV in FIG. 3.

FIG. 5 is a cross-sectional view illustrating a wire harness including the grommet according to Embodiment 1.

FIG. 6 is a diagram illustrating the grommet when a torsion moment is applied thereto.

FIG. 7 is a cross-sectional view illustrating a grommet according to a modification.

### DETAILED DESCRIPTION TO EXECUTE THE INVENTION

### Description of Embodiments

First, modes for carrying out the present disclosure will be listed and described.

The grommet according to the present disclosure is as follows.

(1) A grommet includes: a main body portion that is tubular and into which a wire is to be inserted; and an attaching portion for use in attaching to a target for attachment, wherein the main body portion includes a holding portion for use in holding the wire, and a linking portion joining the holding portion and the attaching portion, and the linking portion includes a recessed/protruding portion in which protruding portions and recessed portions are alternately arranged in a circumferential direction about an axis that is parallel to an insertion direction of the wire. In the grommet, the path in which a torsion moment from the wire is transmitted extends from the holding portion to the attaching portion via the linking portion. In the recessed/protruding portion provided in the linking portion, the protruding portions and the recessed portions are alternately arranged in the circumferential direction about the axis parallel to the insertion direction of the wire, and thus the recessed/protruding portion torsionally deforms easily due to the torsion moment. Accordingly, the torsion moment that is being transmitted from the holding portion toward the attaching portion is likely to be absorbed by the recessed/protruding portion provided on the way. Accordingly, even if a torsion moment is applied from the wire to the grommet, the torsion moment can be suppressed from being transmitted to the attaching portion by the recessed/protruding portion. It is thus possible to suppress torsional deformation in the attaching portion.

(2) In the grommet according to the item (1), preferably, the linking portion includes a tapered portion that is gradually tapered from a portion on the attaching portion side toward a portion on the holding portion side. With this, it is possible to improve the workability when inserting the wire into the main body portion.

(3) In the grommet according to the item (1) or (2), preferably, a ring-shaped lip portion is provided on an inner surface of the holding portion, the ring-shaped lip portion being capable of coming into contact with the wire inserted into the holding portion. With this, inside the holding portion, the lip portion and the wire are likely to come into intimate contact with each other, and an improvement in the water-proofing performance can be achieved.

(4) In the grommet according to any one of the items (1) to (3), preferably, the attaching portion extends from the main body portion so as to intersect with the insertion direction, and in the main body portion, at least the recessed/protruding portion has a thickness that is smaller than a thickness of the attaching portion. With this, the recessed/protruding portion is more likely to torsionally deform than the attaching portion, and a torsion moment from the wire is unlikely to be applied to the attaching portion.

(5) In the grommet according to any one of the items (1) to (4), preferably, the protruding portions and the recessed portions extend from the attaching portion side toward the holding portion, while keeping a protruding shape and a recessed shape. This increases the amount of torsional deformation that the recessed/protruding portion can undergo.

(6) In the grommet according to any one of the items (1) to (5), preferably, a plurality of the main body portions are provided at an interval in a direction that intersects with the insertion direction, and each of the plurality of main body portions includes a recessed/protruding portion. With this, even if a torsion moment is applied to each of the plurality of main body portions, the torsion moment is likely to be absorbed by the recessed/protruding portion provided on the corresponding main body portion.

(7) Also, the wire harness according to the present disclosure is directed to a wire harness including: the grommet according to any one of the items (1) to (6); and a wire that is inserted into the grommet, and is held by the holding portion. In the grommet, the path in which a torsion moment from the wire is transmitted extends from the holding portion to the attaching portion via the linking portion. In the recessed/protruding portion provided in the linking portion, the protruding portions and the recessed portions are alternately arranged in the circumferential direction about the axis parallel to the insertion direction of the wire, and thus the recessed/protruding portion torsionally deforms easily due to the torsion moment. Accordingly, the torsion moment that is being transmitted from the holding portion toward the attaching portion is likely to be absorbed by the recessed/protruding portion provided on the way. Accordingly, even if a torsion moment is applied from the wire to the grommet, the torsion moment can be suppressed from being transmitted to the attaching portion by the recessed/protruding portion, thus making it possible to suppress torsional deformation in the attaching portion.

[Details of Embodiments of the Present Disclosure]

The following will describe specific examples of the grommet and wire harness of the present disclosure with reference to the drawings. Note that the present disclosure is not limited to the examples but is defined by the claims, and all modifications within the meaning and scope equivalent to the claims are intended to be included.

### Embodiment 1

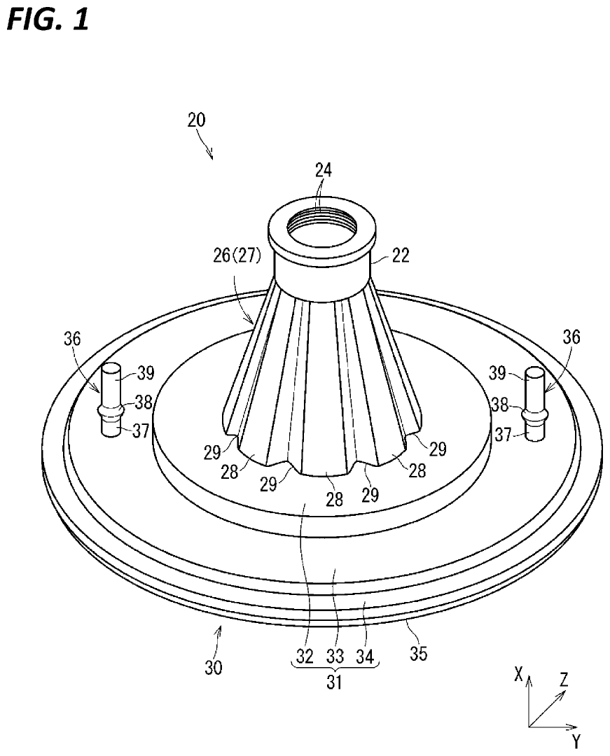

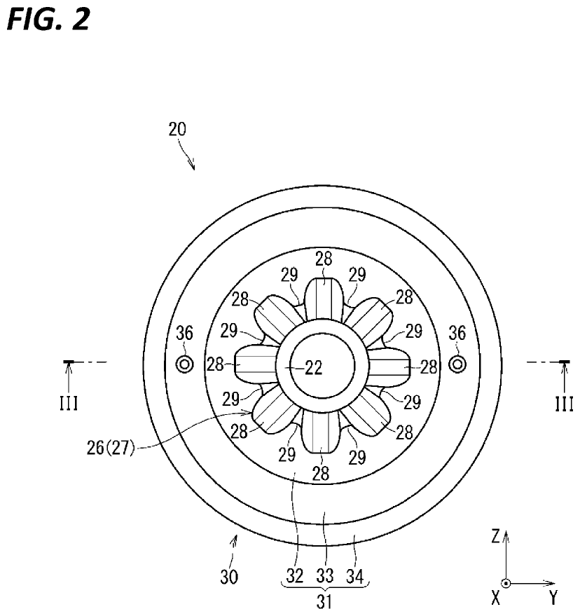

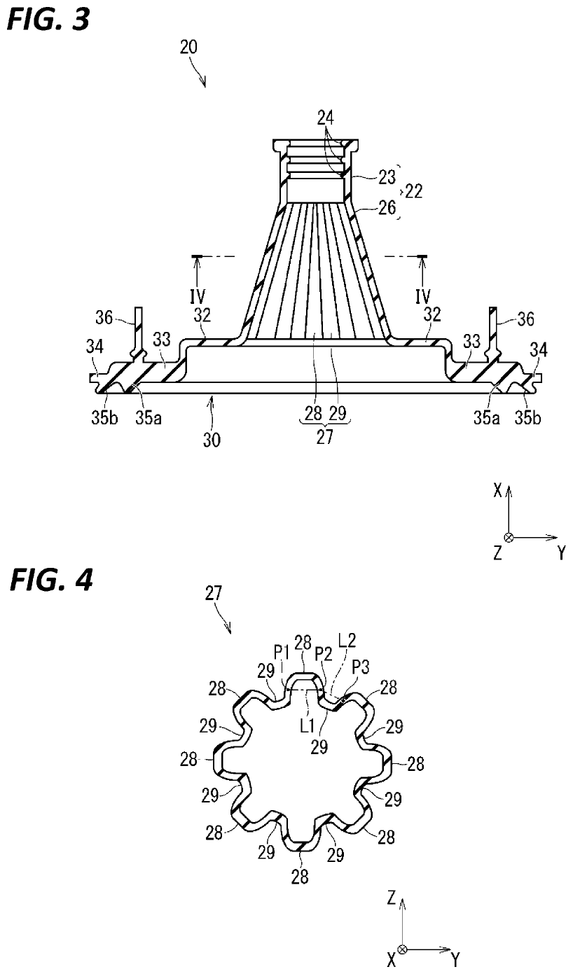

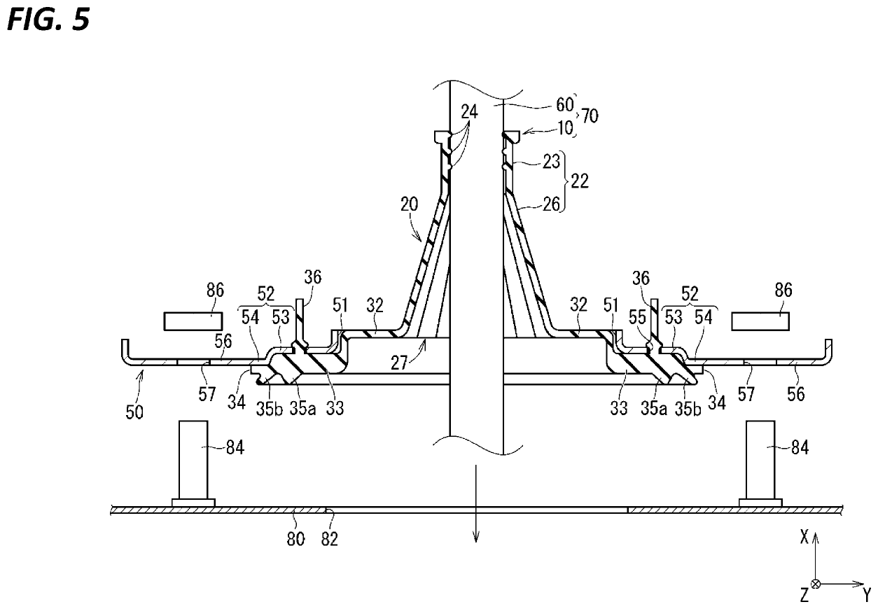

The following will describe a grommet and wire harness according to Embodiment 1. FIG. 1 is a perspective view illustrating a grommet 20 according to Embodiment 1. FIG. 2 is a plan view illustrating the grommet 20 according to Embodiment 1. FIG. 3 is a cross-sectional view taken along a line in FIG. 2. FIG. 4 is a cross-sectional view taken along a line IV-IV in FIG. 3. Note that in FIG. 4, only a cross-sectional portion is extracted and shown. FIG. 5 is a cross-sectional view illustrating a wire harness 70 provided with the grommet 20 according to Embodiment 1.

The grommet 20 is to be attached to a target for attachment. The target for attachment is preferably a member for partitioning a space of a vehicle. Hereinafter, description is given assuming that the target for attachment is a vehicle body panel 80. For example, the vehicle body panel 80 may be a panel (such as, for example, a floor panel) that separates the interior space of the vehicle from the exterior space. Also, for example, the vehicle body panel 80 may be a panel for dividing the interior space of the vehicle into a plurality of spaces (such as, for example, a dash panel separating the passenger compartment from the front compartment).

The vehicle body panel 80 has an insertion hole 82 passing through the vehicle body panel 80. A wire 60 is passed through the insertion hole 82. With this, the wire 60 is arranged so as to extend from one to the other of two spaces separated by the vehicle body panel 80. The grommet 20 prevents water from entering the insertion hole 82 and protects the wire 60. Specifically, the grommet 20 separates, together with the vehicle body panel 80, two spaces from each other in the vicinity of the insertion hole 82. The grommet 20 prevents water, dirt, and the like from entering, via the insertion hole 82, one from the other of the two spaces separated by the vehicle body panel 80. The grommet 20 protects the wire 60 from a member arranged in a rim portion of the insertion hole 82 in the vehicle body panel 80 or in the vicinity of the insertion hole 82.

In the present disclosure, as shown in FIG. 5, among an X-direction, a Y-direction, and a Z-direction that are orthogonal to each other, the X-direction is defined as a direction parallel to a thickness direction of the vehicle body panel 80 (axial direction of the insertion hole 82). The surface of the vehicle body panel 80 in the vicinity of the opening of the insertion hole 82 is a planar surface parallel to a YZ plane. When the grommet 20 in a non-attached state is described, directions that correspond to the X-direction, the Y-direction, and the Z-direction when the grommet 20 is in an attached state are used for the description.

The grommet 20 of the present example is fixed to the vehicle body panel 80 via a bracket 50. The grommet 20 to which the bracket 50 is attached can be regarded as a grommet unit 10. The grommet 20 (grommet unit 10) is mounted to the wire 60. The grommet 20 (grommet unit 10) mounted to the wire 60 can be regarded as the wire harness 70.

<Grommet>

The grommet 20 includes a main body portion 22 and an attaching portion 30. The grommet 20 is an integrally molded article obtained by integrally molding the main body portion 22 and the attaching portion 30. The grommet 20 is made of an elastic material. For example, elastomer such as highly elastic EPDM (ethylene-propylene-diene rubber) can be used as the material of the grommet 20. The grommet 20 may be integrally die-molded with an elastic material as described above.

The main body portion 22 is a portion through which the wire 60 is passed. The main body portion 22 is tubular. Here, the wire 60 is inserted into the grommet 20 in a direction parallel to the X-direction. The direction in which the wire 60 is inserted into the grommet 20 may intersect with the X-direction at an angle other than the orthogonal angle. The main body portion 22 includes a holding portion 23 and a linking portion 26.

The holding portion 23 is a portion for use in holding the wire 60. The holding portion 23 is tubular. The horizontal cross sections of the inner and outer surfaces of the holding portion 23 are circular. The holding portion 23 is continuous in the X-direction with the same inner diameter. The mode in which the holding portion 23 holds the wire 60 is not particularly limited, and can be set as appropriate. For example, the holding portion 23 may have an inner surface that is equal to or smaller than that of the wire 60, and may be configured to fasten and hold the wire 60 with the elasticity of the holding portion 23 itself. Also, for example, the wire 60 that is inserted into the holding portion 23 may be held by winding tape around the holding portion 23 and the wire 60 extending from the holding portion 23. Also, for example, the wire 60 that is inserted into the holding portion 23 may be held by crimping an outer circumferential portion of the holding portion 23 with a crimping member.

It is preferable that the inside of the holding portion 23 be water-proofed with the wire 60 inserted into the holding portion 23. Here, a lip portion 24 is provided for enhancing the water-proofing performance of the inside of the holding portion 23. The lip portion 24 protrudes from the inner surface of the holding portion 23 toward the inner space of the holding portion 23. The lip portion 24 can come into contact with the wire 60 inserted into the holding portion 23. The lip portion 24 is formed as a closed ring on the inner surface of the holding portion 23. As a result of the lip portion 24 and the wire 60 coming into intimate contact with each other over the entirety in a circumferential direction, the water-proofing performance of the inside of the holding portion 23 is enhanced. In the present example, three lip portions 24 are provided. The three lip portions 24 are provided at intervals in the X-direction. However, the number of the lip portions 24 may be one or two, or four or more.

The linking portion 26 is a portion that joins the holding portion 23 and the attaching portion 30. The linking portion 26 is tubular. A first end of the linking portion 26 is joined to the holding portion 23. A second end of the linking portion 26 is joined to the attaching portion 30. The linking portion 26 includes a tapered portion that is gradually tapered from the portion on the attaching portion 30 side (second end side) toward the portion on the holding portion 23 side (first end side). Here, the entire linking portion 26 extending in the X-direction is gradually tapered from the portion on the attaching portion 30 side (second end side) toward the portion on the holding portion 23 side (first end side). Also, here, the tapered portion is uniformly tapered from the portion on the attaching portion 30 side (second end side) toward the portion on the holding portion 23 side (first end side). In the vertical cross section shown in FIG. 3, the outer surface and the inner surface of the tapered portion are formed as inclined surfaces that are inclined with respect to the X-direction.

The linking portion 26 includes a recessed/protruding portion 27. The recessed/protruding portion 27 has a structure in which protruding portions 28 and recessed portions 29 are alternately arranged in the circumferential direction about an axis parallel to the insertion direction (here, X-direction) of the wire 60. The protruding portions 28 protrude in directions (here, directions parallel to the YZ plane) that intersect with the axis. The recessed portions 29 are recessed in the directions (here, directions parallel to the YZ plane) that intersect with the axis. In the present disclosure, the protruding portions 28 are protrusions when viewed from outside, and the recessed portions 29 are recesses when viewed from outside. Note that, in the present example, eight protruding portions 28 and eight recessed portions 29 are provided, but this is not an essential configuration. Preferably, the same multiple number of protruding portions 28 and recessed portions 29 are provided. The protruding portions 28 and the recessed portions 29 may have the same degree of dimensional ratio along the circumferential direction. Alternatively, the ratio of protruding portions 28 may be greater, or the ratio of recessed portions 29 may be greater.

As shown in FIG. 4, the protruding portions 28 are recessed when viewed from the inner circumferential side, and the recessed portions 29 protrude when viewed from the inner circumferential side. That is to say, a portion whose outer surface serves as a protruding portion 28 has the inner surface that is recessed, and a portion whose outer surface serves as a recessed portion 29 has the inner surface that protrudes. Accordingly, the recessed/protruding portion 27 has the inner surface that has an inverted recessed/protruding arrangement with respect to the recessed/protruding arrangement of the outer surface.

Also, here, the portion of the linking portion 26 in which the recessed/protruding portion 27 is provided serves as the taper portion that is gradually tapered from the portion on the attaching portion 30 side toward the portion on the holding portion 23 side. The outer surface of the linking portion 26 is an inclined surface that is inclined with respect to the X-direction from the attaching portion 30 toward the holding portion 23. The protruding portions 28 and the recessed portions 29 extend along the inclined surface from the attaching portion 30 toward the holding portion 23, while keeping the protruding shape and the recessed shape.

Since the outer surface of the linking portion 26 is an inclined surface, the dimensions of the protruding portions 28 and the recessed portions 29 along the circumferential direction vary in the X-direction. Here, the dimensional ratio of the protruding portions 28 and the recessed portions 29 along the circumferential direction may be fixed from the portion on the attaching portion 30 side toward the portion on the holding portion 23 side. Also, the dimensional ratio of the protruding portions 28 and the recessed portions 29 along the circumferential direction may vary such that the ratio of the protruding portions 28 increases or the ratio of the recessed portions 29 increases, from the portion on the attaching portion 30 side toward the portion on the holding portion 23 side.

The protrusion length of each protruding portion 28 from an adjacent recessed portion 29 (height dimension from the bottom of the recessed portion 29 to the top of the protruding portion 28) is not particularly limited, and may be set as appropriate. For example, the protrusion length of the protruding portion 28 from the recessed portion 29 may be set within a range in which it is greater than 0 and is smaller than the radius of the holding portion 23.

A protruding portion 28 extending from the attaching portion 30 toward the holding portion 23 is elongated in the insertion direction rather than in the circumferential direction. Similarly, one recessed portion 29 extending from the attaching portion 30 toward the holding portion 23 is elongated in the insertion direction rather than in the circumferential direction. Note that in the present disclosure, the boundary between a protruding portion 28 and a recessed portion 29 along the circumferential direction is defined at the middle position between the highest position of the protruding portion 28 and the lowest position of the recessed portion 29. The length of a line segment connecting such middle positions is defined as the circumferential dimension of the protruding portion 28 or the recessed portion 29. For example, in the example shown in FIG. 4, the length of a line segment L1 connecting points P1 and P2, which are located on both sides of a protruding portion 28 and serve as the boundaries to the adjacent recessed portions 29, is defined as the dimension of the protruding portion 28 along the circumferential direction. Similarly, the length of a line segment L2 connecting points P2 and P3, which are located on both sides of a recessed portion 29 and serve as the boundaries to the adjacent protruding portions 28, is defined as the dimension of the protruding portion 29 along the circumferential direction. The protruding portions 28 and the recessed portions 29 have a greater dimension along an extending direction of the outer surface of the linking portion 26 than the dimension along the circumferential direction. Here, the dimensions of the protruding portions 28 and the recessed portions 29 along the circumferential direction decrease as the linking portion 26 is tapered. The largest dimensions of the protruding portions 28 and the recessed portions 29 along the circumferential direction, that is, the dimensions of the protruding portions 28 and the recessed portions 29 along the circumferential direction at a position closest to the attaching portion 30 are smaller than the dimensions along the extending direction.

Furthermore, here, the dimensions of the protruding portions 28 and the recessed portions 29 along the insertion direction are greater than the dimensions along the circumferential direction. The dimensions along the insertion direction are equal to the dimension of the linking portion 26 along the X-direction. The largest dimensions of the protruding portions 28 and the recessed portions 29 along the circumferential direction, that is, the dimensions of the protruding portions 28 and the recessed portions 29 along the circumferential direction at a position closest to the attaching portion 30 are smaller than the dimensions along the insertion direction.

The attaching portion 30 is a portion for use in attaching to a target for attachment (here, the vehicle body pan 80). The attaching portion 30 extends from the main body portion 22 so as to intersect with the insertion direction. The attaching portion 30 includes a flange portion 31 and a lip portion 35. The bracket 50 is arranged on the surface of the flange portion 31 that faces the holding portion 23 (the positive side in the X-direction). The flange portion 31 of the attaching portion 30 is interposed between the vehicle body panel 80 and the bracket 50. Also, the surface of the flange portion 31 that is opposite to the surface facing the holding portion 23 (the positive side in the X-direction) is a surface facing to the vehicle body panel 80. The lip portion 35 is provided on this surface.

The flange portion 31 extends from an end of the linking portion 26 so as to intersect with the insertion direction. As the flange portion 31, a first flange portion 32, a second flange portion 33, and a third flange portion 34 are provided. The outer edges of the first flange portion 32, the second flange portion 33, and the third flange portion 34 are circular. The first flange portion 32 is joined to the end of the linking portion 26. The second flange portion 33 is provided on the outer circumferential side of the first flange portion 32. The outer diameter of the second flange portion 33 is larger than that of the insertion hole 82. The third flange portion 34 is provided on the outer circumferential side of the second flange portion 33. The second flange portion 33 and the third flange portion 34 are interposed between the vehicle body panel 80 and the bracket 50.

The surface of the first flange portion 32 that faces the holding portion 23 (the positive side in the X-direction) and the surface of the second flange portion 33 that faces the holding portion 23 (the positive side in the X-direction) are shifted in the X-direction. Therefore, there is a level difference between the surface of the first flange portion 32 that faces the holding portion 23 (the positive side in the X-direction) and the surface of the second flange portion 33 that faces the holding portion 23 (the positive side in the X-direction). The surface of the second flange portion 33 that faces the holding portion 23 (the positive side in the X-direction) and the surface of the third flange portion 34 that faces the holding portion 23 (the positive side in the X-direction) are shifted in the X-direction. Therefore, there is a level difference between the surface of the second flange portion 33 that faces the holding portion 23 (the positive side in the X-direction) and the surface of the third flange portion 34 that faces the holding portion 23 (the positive side in the X-direction). Due to the level difference between the first flange portion 32 and the second flange portion 33, and the level difference between the second flange portion 33 and the third flange portion 34, positioning of the grommet 20 and the bracket 50 is easy.

The first flange portion 32 and the second flange portion 33 have different thicknesses. The second flange portion 33 and the third flange portion 34 have different thicknesses. The thickness of the second flange portion 33 is greater than the thickness of the first flange portion 32 and the thickness of the third flange portion 34. Also, in the main body portion 22, at least the recessed/protruding portion 27 has a thickness that is smaller than the thickness of the attaching portion 30, particularly, the thickest portion (here, the second flange portion 33) of the portion pressed by the bracket 50 except for the lip portion 35. The thickness of the recessed/protruding portion 27 is equal to the thickness of the first flange portion 32. However, the thicknesses of the portions of the grommet 20 are not limited to those, and may be set as appropriate. For example, in the main body portion 22, at least the recessed/protruding portion 27 may have a thickness that is equal to or greater than the thickness of the attaching portion 30, particularly, the thickest portion (here, the second flange portion 33) of the portion pressed by the bracket 50 except for the lip portion 35.

The lip portion 35 realizes water-proofing between the grommet 20 and the vehicle body panel 80. The lip portion 35 is annular. The lip portion 35 can come into intimate contact with the vehicle body panel 80 while surrounding the entire circumference of the opening of the insertion hole 82. In the present example, two lip portions 35 are provided. Of two lip portions 35a and 35b, the lip portion 35a is located on the inner circumferential side, and the lip portion 35b is located on the outer circumferential side. Therefore, the diameter of the lip portion 35b is larger than that of the lip portion 35a. The two lip portions 35 are provided near the level difference between the second flange portion 33 and the third flange portion 34. The lip portion 35a is provided on the second flange portion 33, and the lip portion 35b extends over the boundary between the second flange portion 33 and the third flange portion 34.

<Bracket>

The bracket 50 covers the attaching portion 30 from one side and fixes the attaching portion 30 to the vehicle body panel 80. The bracket 50 includes a bracket main body 52 and a fixing portion 56. By, for example, bending and pressing a metal plate material, the bracket 50 is shaped to have the bracket main body 52 and the fixing portion 56.

The bracket main body 52 is in surface contact with the flange portion 31 in the thickness direction. The bracket main body 52 can press the flange portion 31 toward the rim portion of the insertion hole 82 in the vehicle body panel 80. The bracket main body 52 is annular. The bracket main body 52 has a through hole 51 through which the main body portion 22 of the grommet 20 is passed. The diameter of the through hole 51 is equal to or greater than (here, slightly greater than) that of the first flange portion 32. The first flange portion 32 is passed through the through hole 51. With this, the grommet 20 and the bracket 50 are positioned. The bracket main body 52 is in surface contact with the second flange portion 33 and the third flange portion 34. The bracket main body 52 includes a first portion 53 and a second portion 54. The first portion 53 has a shape that corresponds to the second flange portion 33. The first portion 53 is in surface contact with the second flange portion 33. The second portion 54 has a shape that corresponds to the third flange portion 34. The second portion 54 is in surface contact with the third flange portion 34. Between the first portion 53 and the second portion 54, a level difference is provided that corresponds to the level difference between the second flange portion 33 and the third flange portion 34.

The fixation portion 56 is used for fixation to the vehicle body panel 80. The fixing portion 56 is provided at a position apart from the insertion hole 82 to the outer circumferential side, and can be fixed to the vehicle body panel 80 partially along the circumferential direction. The fixing portion 56 extends radially outward from part of the outer edge of the bracket main body 52. In the present example, a pair of fixing portions 56 are provided at an interval of 180 degrees. Three or more fixing portions may also be provided. Three or more fixing portions may be provided at an equal interval in the circumferential direction. Also, each fixing portion 56 has a fixation hole 57 passing through the fixing portion 56. A bolt 84 fixed to the vehicle body panel 80 is passed through the fixation hole 57 and is fastened. Note that, in the example shown in FIG. 5, the head of the bolt 84 is fixed, by welding or the like, to the surface of the vehicle body panel 80 on which the bracket 50 is arranged. However, the fixation mode of the bolt 84 to the vehicle body panel 80 is not limited to this. For example, the bolt 84 may also be fixed so that the shaft of the bolt 84 is passed through the vehicle body panel 80.

The bracket 50 is arranged so that the flange portion 31 of the grommet 20 is held between the bracket main body 52 and the vehicle body panel 80. By engaging a nut 86 with the bolt 84 passed through the fixation hole 57, the bracket 50 is fixed to the vehicle body panel 80, and due to the fixation of the bracket 50 and the vehicle body panel 80, the grommet 20 is fixed to the vehicle body panel 80. The lip portions 35 of the grommet 20 thus fixed come into intimate contact with the vehicle body panel 80. With this, water-proofing is realized between the grommet 20 and the vehicle body panel 80.

The grommet 20 and the bracket 50 include a temporal fixation portion for temporarily fixing the grommet 20 and the bracket 50 before the bracket 50 is fixed to the vehicle body panel 80. A projection 36 and a lock hole 55 are provided as the temporal fixation portion. The projection 36 is provided on the grommet 20. The lock hole 55 is formed in the bracket 50.

The projection 36 protrudes from the flange portion 31 (here, the second flange portion 33) in the X-direction. The lock hole 55 is formed in the bracket main body 52 at a position corresponding to the projection 36. The lock hole 55 passes through the bracket main body 52. The projection 36 passes through the lock hole 55. Before being fixed to the vehicle body panel 80, the projection 36 is inserted and locked into the lock hole 55, and the bracket 50 is held by the grommet 20. A plurality of pairs of projections 36 and lock holes 55 are provided. In the present example, two pairs of projections 36 and lock holes 55 are provided at an interval of 180 degrees.

The projection 36 includes a base end portion 37, an intermediate portion 38, and a leading end portion 39. The base end portion 37 is a portion that is joined to the flange portion 31. The intermediate portion 38 and the leading end portion 39 are provided on the leading end side with respect to the base end portion 37. At least part of the base end portion 37 is received in the lock hole 55. The intermediate portion 38 is joined to the base end portion 37. The intermediate portion 38 is thicker than the base end portion 37 and the leading end portion 39. The intermediate portion 38 is larger than the lock hole 55. When passing through the lock hole 55, the intermediate portion 38 is compressed due to being subjected to a force from, for example, the rim portion and the inner surface of the lock hole 55, and elastically deforms. Due to the force from the bracket 50 decreasing after the intermediate portion 38 has passed through the lock hole 55, the intermediate portion 38 elastically recovers and is locked to the rim portion of the lock hole 55. The leading end portion 39 is joined to the intermediate portion 38. For example, an operator can, while holding the leading end portion 39, insert and lock the projection 36 into the corresponding lock hole 55.

<Wire Harness>

As described above, the wire harness 70 is such that the grommet 20 (grommet unit 10) is mounted to the wire 60. The wire harness 70 includes the above-described grommet 20 (grommet unit 10) and the wire 60. The wire 60 is inserted into the grommet 20 and is held by the holding portion 23.

The wire 60 alone may be inserted into the grommet 20. In this case, the inner surface of the holding portion 23 is in contact with a coated portion of the wire 60. A configuration is also possible in which an exterior member is mounted to the outer circumferential portion of the wire 60, and the wire 60 is inserted together with the exterior member into the grommet 20. In this case, the inner surface of the holding portion 23 is at least partially in contact with the outer surface of the exterior member.

The exterior member is not particularly limited, and any exterior member may be used as long as it is insertable into the grommet 20 together with the wire 60. For example, the exterior member may be adhesive tape that bundles together a plurality of wires 60. Also, for example, the exterior member may be a tubular member such as a corrugated tube. Also, for example, the exterior member may be a sheet-shaped member wound around the wire 60.

Furthermore, one or more wires 60 may be inserted into the grommet 20. The wire 60 may be used for power supply or signaling. A low-voltage wire or a high-voltage wire may be used as a wire for power supply. For example, a single high-voltage wire 60 may be inserted into the grommet 20.

<Regarding Torsional Deformation of Grommet>

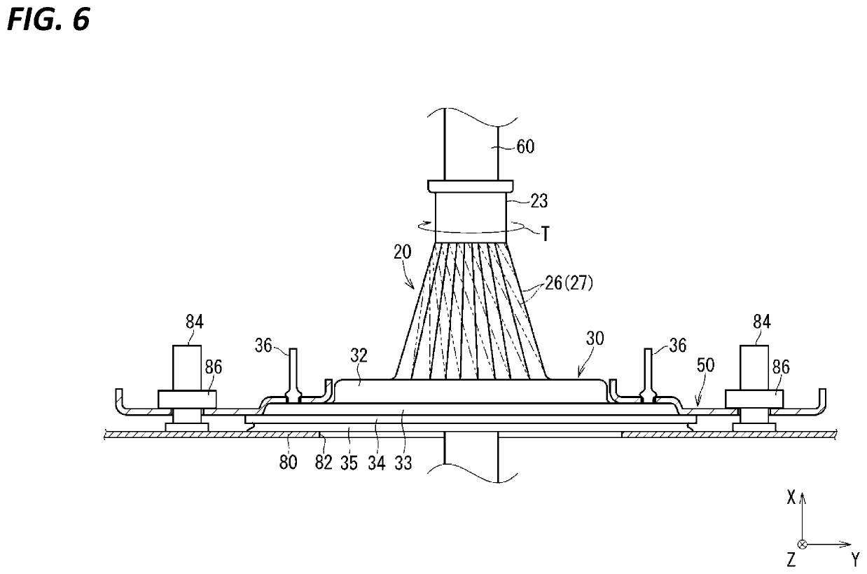

The following will describe a state of the grommet 20 when a torsion moment is applied thereto with the wire harness 70 fixed to the vehicle body panel 80. FIG. 6 is a diagram illustrating the grommet 20 when a torsion moment T is applied thereto. In FIG. 6, the linking portion 26 indicated by solid lines shows a state before the torsion moment T is applied, and the linking portion 26 indicated by virtual lines shows a state after the torsion moment T has been applied. Also, in FIG. 6, some of members are shown in cross-sectional views.

As shown in FIG. 6, a torsion moment T from the wire 60, that is, a torsion moment T about the axis parallel to the X-direction is applied to the holding portion 23 that holds the wire 60. The holding portion 23 serves as a free end, and is thus likely to rotate about the axis together with the wire 60. When the portion of the grommet 20 subjected to a torsion moment T is rotated, the torsion moment T is transmitted to the attaching portion 30 side with respect to the rotated portion. On the other hand, the attaching portion 30 is fixed to the vehicle body panel 80 and serves as a fixed end, and is thus unlikely to rotate about the axis. Accordingly, torsional deformation due to a torsion moment T may occur in the grommet 20 at a position between the holding portion 23 and the fixing portions 56 of the attaching portion 30.

The holding portion 23 is substantially uniform tube-shaped from the end on the linking portion 26 side (lower side of FIG. 6) to the opposite end (upper side of FIG. 6). Therefore, when a torsion moment T is applied to the holding portion 23, the end of the holding portion 23 on the linking portion 26 side (lower side of FIG. 6) also deforms so as to rotate about the axis. With this, a first end portion of the linking portion 26 that is joined to the holding portion 23 also deforms so as to rotate about the axis together with the holding portion 23. On the other hand, a second end portion of the linking portion 26 that is joined to the attaching portion 30 is unlikely to rotate about the axis since the attaching portion 30 is fixed to the vehicle body panel 80. As a result, torsional deformation due to a torsion moment T is likely to occur in the linking portion 26 of the grommet 20.

In the present disclosure, the recessed/protruding portion 27 is formed in this linking portion 26. Due to the recessed/protruding shape, the recessed/protruding portion 27 torsionally deforms easily, compared to a case where it is tubular. The recessed/protruding portion 27 torsionally deforms easily, compared to the holding portion 23 and the attaching portion 30. Also, when the recessed/protruding portion 27 torsionally deforms, the recessed/protruding portion 27 can absorb the torsion moment T. That is to say, the magnitude of the torsion moment T applied to the first end portion of the recessed/protruding portion 27 gradually decreases while the torsion moment T is transmitted toward the second end portion. Therefore, the torsion moment T is unlikely to be transmitted to the attaching portion 30 joined to the second end portion. As described above, in the present disclosure, the torsion moment T applied to the holding portion 23 is unlikely to be transmitted to the attaching portion 30 because it is absorbed by the recessed/protruding portion 27 on the way. Accordingly, the attaching portion 30 is suppressed from torsionally deforming due to the torsion moment T.

Furthermore, in the present disclosure, because, during the torsional deformation of the recessed/protruding portion 27, the portions between the top of the protruding portion 28 and the bottom of the recessed portion 29 deform, the difference in rotation amount therebetween can be absorbed. Therefore, new wrinkles or the like are less likely to be generated during the torsional deformation of the recessed/protruding portion 27, and thus the attaching portion 30 is suppressed from getting wrinkled. Also in this view, the attaching portion 30 is suppressed from deforming due to the torsion moment T.

Also, if the bracket 50 and the vehicle body panel 80 are fixed at two positions, the grommet 20 is more likely to be affected by the torsional deformation of the main body portion 22 in the portion between the two fixation positions than in a position in the vicinity of the two fixation positions. With this, the sealing pressure in the ring-shaped lip portion 35 may differ depending on the position. Also in this case, the recessed/protruding portion 27 can suppress the attaching portion 30 from torsionally deforming due to the torsion moment T, and thus the sealing pressure in the lip portion 35 is not likely to differ depending on the position.

Also, the bracket 50 is held on the grommet 20 via two pairs of projections 36 and lock holes 55. When the grommet 20 and the bracket 50 are fixed at two positions, the grommet 20 may be more likely to be affected by the torsional deformation of the main body portion 22 in the portion between the two fixation positions than in a position in the vicinity of the two fixation positions. With this, the sealing pressure in the ring-shaped lip portion 35 may differ depending on the position. Also in this case, the recessed/protruding portion 27 can suppress the attaching portion 30 from torsionally deforming due to the torsion moment T, and thus the sealing pressure in the lip portion 35 is not likely to differ depending on the position.

<Effects Etc.>

According to the grommet 20 having the above-described configuration, and the wire harness 70 including such a grommet 20, the path of the grommet 20 in which a torsion moment T from the wire 60 is transmitted extends from the holding portion 23 to the attaching portion 30 via the linking portion 26. In the recessed/protruding portion 27 provided in the linking portion 26, the protruding portions 28 and the recessed portions 29 are alternately arranged in the circumferential direction about an axis parallel to the insertion direction of the wire 60, and thus the recessed/protruding portion 27 torsionally deforms easily due to the torsion moment T. Accordingly, the torsion moment T that is being transmitted from the holding portion 23 toward the attaching portion 30 is likely to be absorbed by the recessed/protruding portion 27 provided on the way. Accordingly, even if a torsion moment T is applied from the wire 60 to the grommet 20, the torsion moment T can be suppressed from being transmitted to the attaching portion 30 by the recessed/protruding portion 27, thus making it possible to suppress the attaching portion 30 from torsionally deforming.

Also, the linking portion 26 includes a tapered portion that is gradually tapered from the portion on the attaching portion 30 side toward the portion on the holding portion 23 side. With this, it is possible to improve the workability when inserting the wire 60 into the main body portion 22. More specifically, the inner surface of the holding portion 23 has about the same area as the outer surface of the wire 60. Also, when the wire 60 is inserted into the holding portion 23, the insertion of the wire 60 is performed with the holding portion 23 expanded by a jig or the like. At this time, since the linking portion 26 includes the tapered portion that is gradually tapered from the portion on the attaching portion 30 side toward the portion on the holding portion 23 side, the tapered portion does not need to be expanded by a jig or the like, or even if the tapered portion is expanded, it only needs to be expanded a little bit. Because the operation of expanding the holding portion 23 is easy in this way, it is possible to improve the workability when inserting the wire 60 into the main body portion 22.

Also the ring-shaped lip portion 24 capable of coming into contact with the wire 60 inserted into the holding portion 23 is provided on the inner surface of the holding portion 23. With this, inside the holding portion 23, the lip portion 24 and the wire 60 are likely to come into intimate contact with each other, and an improvement in the water-proofing performance can be improved.

Also, the attaching portion 30 extends from the main body portion 22 so as to intersect with the insertion direction, and, in the main body portion 22, at least the recessed/protruding portion 27 has a thickness that is smaller than that of the attaching portion 30. With this, the recessed/protruding portion 27 torsionally deforms easily, compared to the attaching portion 30, and the torsion moment T from the wire 60 is unlikely to be applied to the attaching portion 30.

Also, the protruding portions 28 and the recessed portions 29 extend from the attaching portion 30 side toward the holding portion 23, while keeping the protruding shape and the recessed shape. This increases the amount of torsional deformation that the recessed/protruding portion 27 can undergo.

[Modifications]

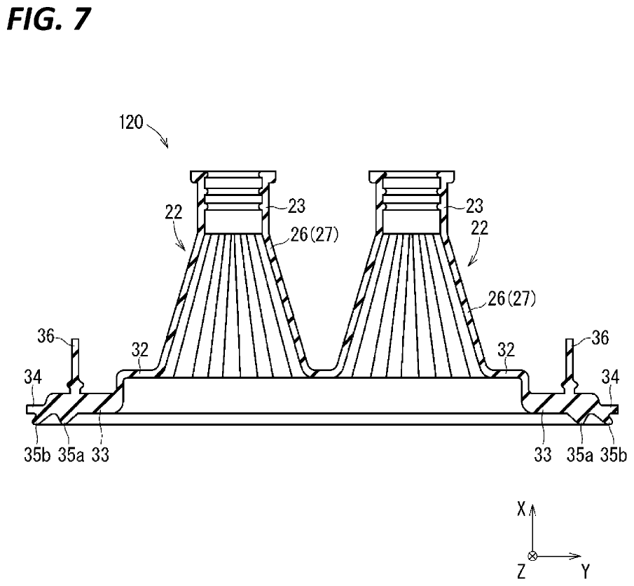

FIG. 7 is a cross-sectional view illustrating a grommet 120 according to a modification.

Although Embodiment 1 has described an example in which one main body portion 22 is provided, this is not essential configuration. As in the case of the grommet 120, the single grommet 120 may include a plurality of main body portions 22. The plurality of main body portions 22 are provided at intervals in a direction (here, direction parallel to the YZ plane) that intersects with the insertion direction. Each of the plurality of main body portions 22 includes a recessed/protruding portion 27. With this, even if a torsion moment T is applied to each of the plurality of main body portions 22, the torsion moment T is likely to be absorbed by the recessed/protruding portion 27 provided on the corresponding main body portion 22.

For example, if torsion moments Tin opposite directions are respectively applied to two holding portions 23, and the torsion moments T are transmitted to the attaching portions 30, the attaching portion 30 will be subjected to a large force such that part of the attaching portion 30 is compressed and the other part is extended. Also in this case, the recessed/protruding portion 27 provided on each holding portion 23 can absorb such a torsion moment T applied to this holding portion 23, and the attaching portion 30 is not likely to be subjected to torsional deformation.

The plurality of main body portions 22 have the same shape. In this example, each main body portion 22 has the same shape as that of the main body portion 22 that has been described in Embodiment 1. The plurality of main body portions 22 may also have different shapes. For example, the holding portion of a first main body portion may have an inner diameter that is larger than the inner diameter of the holding portion of a second main body portion. With this, for example, the dimension and the number of wires 60 to be inserted can be changed between the first main body portion and the second main body portion. Also, for example, the shape of the recessed/protruding portion of the first main body portion may differ from the shape of the recessed/protruding portion of the second main body portion. With this, for example, the torsional deformability, the amount of absorption of the torsion moment T, or the like can be changed between the first main body portion and the second main body portion.

Moreover, a description has been given in which the linking portion 26 of the grommet 20, 120 is a tapered portion that is gradually tapered in the X-direction, but this is not an essential configuration. For example, the linking portion of the grommet may have a shape such that the same cross-sectional shape continues in the X-direction.

Also, a description has been given in which the lip portion 24 of the grommet 20, 120 is provided on the inner surface of the holding portion 23, but this is not an essential configuration. The lip portion 24 of the grommet does not need to be provided on the inner surface of the holding portion.

Also, a description has been given in which the protruding portions 28 and the recessed portions 29 of the grommet 20, 120 are elongated in the insertion direction rather than in the circumferential direction, but this is not an essential configuration. The protruding portions and the recessed portions may also be elongated in the circumferential direction rather than in the insertion direction. The protruding portions and the recessed portions may have the same dimensions both in the insertion direction and in the circumferential direction.

Also, a description has been given in which the grommet 20, 120 is fixed to the vehicle body panel 80 using the bracket 50, but this is not an essential configuration. A configuration is also possible in which the grommet is fixed to the vehicle body panel 80 without using the bracket 50. For example, the grommet may have, at the outer edge of the attaching portion, a groove with which the rim portion of the insertion hole 82 in the vehicle body panel 80 is fitted.

Although a description has been given in which the insertion hole 82 is circular, this is not an essential configuration. The insertion hole may have a shape other than a circular shape. For example, the insertion hole may be elliptical, oval, polygonal. Also, the attaching portion of the grommet may be elliptical, oval, polygonal, conforming to the shape of the insertion hole. In this case, the torsional deformation of the main body portion 22 does not uniformly propagate to the attaching portion, and thus the sealing pressure may be likely to differ depending on the position. Also in this case, as a result of a torsion moment T being absorbed by the recessed/protruding portion 27, it is possible to suppress torsional deformation in the attaching portion.

Note that the above-described embodiment and modifications can be freely combined unless they contradict each other.

### LIST OF REFERENCE NUMERALS

10 Grommet unit
20 Grommet
22 Main body portion
23 Holding portion
24 Lip portion
26 Linking portion
27 Recessed/protruding portion
28 Protruding portion
29 Recessed portion
30 Attaching portion
31 Flange portion
32 First flange portion
33 Second flange portion
34 Third flange portion
35, 35a, 35b Lip portion
36 Projection
37 Base end portion
38 Intermediate portion
39 Leading end portion
50 Bracket
51 Through hole
52 Bracket main body
53 First portion
54 Second portion
55 Lock hole
56 Fixed portion
57 Fixation hole
60 Wire
70 Wire harness
80 Vehicle body panel (target for attachment)
82 Insertion hole
84 Bolt
86 Nut
T Torsion moment

1. A grommet comprising:
a main body portion that is tubular and into which a wire is to be inserted; and
an attaching portion for use in attaching to a target for attachment,
wherein the main body portion includes a holding portion for use in holding the wire, and a linking portion joining the holding portion and the attaching portion, and
the linking portion includes a recessed/protruding portion in which protruding portions and recessed portions are alternately arranged in a circumferential direction about an axis that is parallel to an insertion direction of the wire.

2. The grommet according to claim 1,
wherein the linking portion includes a tapered portion that is gradually tapered from a portion on the attaching portion side toward a portion on the holding portion side.

3. The grommet according to claim 1,
wherein a ring-shaped lip portion is provided on an inner surface of the holding portion, the ring-shaped lip portion being capable of coming into contact with the wire inserted into the holding portion.

4. The grommet according to claim 1,
wherein the attaching portion extends from the main body portion so as to intersect with the insertion direction, and
in the main body portion, at least the recessed/protruding portion has a thickness that is smaller than a thickness of the attaching portion.

5. The grommet according to claim 1,
wherein the protruding portions and the recessed portions extend from the attaching portion side toward the holding portion, while keeping a protruding shape and a recessed shape.

6. The grommet according to claim 1,
wherein a plurality of the main body portions are provided at an interval in a direction that intersects with the insertion direction, and
each of the plurality of main body portions includes a recessed/protruding portion.

7. A wire harness comprising:
the grommet according to claim 1; and
a wire that is inserted into the grommet, and is held by the holding portion.
